(19) United States
(12) Patent Application Publication
(10) Pub. No.: US 2016/0026419 A1
(43) Pub. Date: Jan. 28, 2016

(54) IMAGE DATA GENERATION

(71) Applicant: VIDEOJET TECHNOLOGIES INC., Wood Dale, IL (US)

(72) Inventors: Steven Buckby, Nottinghamshire (GB); James Butcher, Nottinghamshire (GB)

(21) Appl. No.: 14/774,470

(22) PCT Filed: Mar. 13, 2014
(86) PCT No.: PCT/US2014/025379

§ 371 Date: Sep. 10, 2015

(30) Foreign Application Priority Data
Mar. 15, 2013 (GB) 1304787.3

(51) Int. Cl. G06F 3/12

(52) U.S. Cl. CPC G06F 3/1254; G06F 3/1219; G06F 3/1257

(57) ABSTRACT

A method of generating data associated with printing an image. The method comprises receiving data defining an image design specification, generating a plurality of options for printing an image based upon the image design specification, 5 displaying data based upon the plurality of options to a user, receiving selection of one of the options from the user, and generating the data associated with printing an image based upon the selected option.

The present invention relates to methods of generating data associated with printing an image.

Printers take as input image data representing an image to be printed, the image data being data that when processed by the printer causes the image to be printed on to a substrate. For example, in industrial applications, printers are provided with image data representing an image of information associated with a product for printing on to the product. The image data is typically generated by a printer based upon an image design specification that provides a template into which the printer inserts information that is only available at the time of printing the substrate such as a best before date and a lot number. Such printers used in industrial applications are sometimes referred to as coders.

Printers typically have different modes that can be used to print an image. For example various print modes are known for thermal transfer printers, which cause transfer of ink from a tape carrier to a substrate to print an image, to optimize efficiency of the usage of ink on the tape and therefore to reduce usage of tape. Examples of such print modes can be found for example in International Patent Publication Numbers WO2006/013348, WO2002/070267 and WO2002/022371. The print mode is typically selected by an operator of the printer at the time of printing, however such ink saving print modes are often under utilised because the operator does not fully understand the print modes and the effects of the print modes on the image that is printed based upon the image design specification, or because the image design does not enable the ink saving methods to be used. There is therefore a need for improvements in generation of selection of data associated with printing an image, and in particular improvements in selection of print modes for printing.

It is an object of the invention to obviate or mitigate at least one of the problems set out above.

According to a first aspect of the invention there is provided a method of generating data associated with printing an image. The method comprises receiving data defining an image design specification; generating a plurality of options for printing an image based upon the image design specification; displaying data based upon the plurality of options to a user; receiving selection of one of the options from the user; and generating the data associated with printing an image based upon the selected option.

A printer to be used to print images based upon an image design specification may have a plurality of print modes that allow the printer to be operated in a manner that provides advantageous printer operation. Displaying data to a user based upon the plurality of available options provides information to the user that assists in the selection of one of the plurality of options and can provide improvements, for example in speed and ink usage, and additionally printer uptime as fewer changes of print material may be required, with associated effects on printed image quality that have been assessed and deemed acceptable.

The image design specification may specify a plurality of data fields. Each data field may be associated with information such as a use by date to be printed. The image design specification may further specify relative positions of the plurality of data fields. The method may further comprise printing an image based upon the generated data, the image being printed using an industrial printer selected from the group consisting of: a continuous inkjet printer; a thermal transfer printer; and a drop-on-demand printer. The image that is printed may comprise further information, the further information being determined based upon the plurality of data fields specified in the image design specification. For example, where the image design specification specifies a data field associated with a date, the image that is printed may include a corresponding date. The date included in the image may be included based upon data available at the time of printing such as a current date that may not be available at the time of generation of the image design specification. The image design specification may therefore provide a layout for information to be printed without necessarily including the information itself.

The options may comprise options for controlling a printer to print an image based upon the image design specification. That is, the options may be associated with a printer that may be controlled in a plurality of different ways based upon the plurality of options. The printing may be to be performed by a transfer printer and the options may comprise options affecting efficiency of tape usage and/or speed of printing and/or uptime. For example, the options may be options that use tape more efficiently or that increase a maximum number of prints in a predetermined time period. Alternatively the printing may be to be performed by other types of printer such as thermal transfer printers, drop-on-demand printers and continuous ink-jet printers and the options may comprise options that affect factors specific to those printer types.

One of the options may comprise omitting printing parts of the image defined by the image design specification. For example, one of the options may comprise printing a plurality of parts of the image defined by the image design specification and omitting a plurality of parts of the image defined by the image design specification, the omitted parts being located intermediate printed parts of the image, so as to allow for interleaving of images on a transfer medium. That is, one of the options may allow first and second images to be printed from a contiguous tape region with the first and second images being printed from subregions of the contiguous tape region that overlap.

The method may further comprise determining a plurality of printer operational parameters wherein generating the plurality of options for printing an image is based upon the image design specification and the printer operational parameters. The plurality of options may therefore be determined based upon the printer that is to be used to print images using the image design specification.

The printer operational parameters may be selected from the group consisting of: print speed; substrate speed; a substrate distance between two consecutive prints; a dimension; and any other suitable printer operational parameters.

The data displayed based upon the plurality of options may consist of, for each option, at least one of: a speed of printing; an efficiency of tape usage; and a graphical representation of an image printed based upon the image design specification. The speed of printing may be for example a number of images that can be printed based upon the image design specification in a given time period, for example a number of images per minute defining a number of packages such as bags that can be printed.

The generated data may comprise data based upon a combination of the selected option and other ones of the plurality of options. The method may further comprise displaying data based upon the combination of the selected option and other ones of the plurality of options. For example, the displayed data may indicate which of the other ones of the plurality of options are combinable with the selected option. For example, the displayed data may display options that cannot be combined with the selected option by highlighting the options that cannot be combined, for example by greying out options that cannot be combined. Additionally or alternatively the displayed data may indicate an effect of combining other ones of the plurality of options with the selected option. In particular, the displayed data may be updated for each of the options that can be selected to indicate data based upon the combination of the selected option and the other options.

The generated data associated with printing an image based upon the selected option may comprise data arranged to cause a printer to print images based upon the image design specification using the selected option. For example, the image design specification may be updated to include data indicating the selected option and when the image design specification is processed by a printer the printer may be caused to use the selected option for printing images based upon the image design specification automatically.

According to a second aspect of the invention there is provided a method for modifying an image design specification to optimise a printing process. The method comprises: analysing the image design specification to determine whether the image design specification satisfies a predetermined criterion; if the analysis determines that the image design specification satisfies the predetermined criterion, generating output associated with a first printing mode; if the analysis determines that the image design specification does not satisfy a predetermined criterion, providing a modification of the image design specification.

By analysing an image design specification in this way, it can be determined whether a printing mode can be used and if the printing mode cannot be used a modification of the image design specification can be provided to an operator that would allow use of the printing mode. The operator therefore is able to determine whether such a modification is suitable and if the modification is suitable the modification can be made to allow advantageous printing modes to be used.

The first printing mode may be a printing mode that affects efficiency of tape usage and/or speed of printing. The modification of the image design specification may be based upon the first printing mode. The first printing mode may be associated with the predetermined criterion. That is, the first printing mode may have an associated predetermined criterion that is required to be met in order for the first printing mode to be used.

The first printing mode may be a mode for controlling a printer to print an image based upon the image design specification. The printing may be to be performed by a transfer printer and the printing modes may affect efficiency of tape usage and/or speed of printing. For example, printing modes may include modes in which different tape sizes are used for printing.

Analysing the image design specification may comprise analysing unprinted regions indicated by the image design specification. For example the image design specification may specify image components to be printed within a region of a substrate and the analysing may comprise analysing the regions between the image components to be printed.

Providing a modification of the image design specification may comprise modifying the image design specification such that the image design specification satisfies the predetermined criterion.

Providing a modification of the image design specification may comprise modifying unprinted regions indicated by the image design specification. For example, unprinted regions may be increased or decreased in size. Such increase or decrease in size may allow the first print mode to be used.

Analysing the image design specification may comprise determining a pixel density associated with the image design specification. For example, some print modes print only some of the pixels of an image and such a print mode typically requires a minimum pixel density.

Providing a modification of the image design specification may comprise modifying a font associated with the image design specification. It will be appreciated that modifying a font may alter a size associated with text to be printed in the font and may therefore allow a print mode to be used. For example, text that may be inserted at the time of printing based upon the image design specification may have different maximum sizes based upon different fonts.

Providing a modification of the image design specification may comprise modifying a size of an image region associated with the image design specification. Such modification of an image region may be effected in any convenient way, for example by modification of a font as set out above. In some embodiments, reduction of a maximum size of an image region can allow use of a print mode in which a smaller tape is used for printing, which typically reduces cost. For example, reducing the size of a font of text that may be inserted as described above may allow a smaller tape to be used for printing.

Providing a modification of the image design specification may comprise displaying an effect of a suggested modification of the image design specification. The method may further comprise receiving user input based upon the suggested modification and modifying the image design specification based upon the user input. For example the effect may be displayed to a user by providing a graphical representation of an image that would be printed using the suggested modification to allow the user to determine whether such a modification provides an acceptable printed image and the user may provide a selection of the modification based upon the effect.

The method may further comprise analysing the image design specification to determine whether the image design specification satisfies a further predetermined criterion, generating respective output associated with a printing mode associated with each predetermined criterion satisfied by the image design specification and providing a respective modification of the image design specification for each predetermined criterion not satisfied by the image design specification. For example, a plurality of predetermined criterion may each be associated with a respective print mode and the image design specification may be analysed to determine which of the print modes may be used to print images based upon the image design specification.

It will be appreciated that aspects of the invention can be implemented in any convenient form. For example, the invention may be implemented by appropriate computer programs which may be carried on appropriate carrier media which may be tangible carrier media (e.g. disks) or intangible carrier media (e.g. communications signals). Aspects of the invention may also be implemented using suitable apparatus which may take the form of programmable computers running computer programs arranged to implement the invention or running on the printer itself.

Embodiments of the present invention will now be described, by way of example, with reference to the accompanying drawings in which:

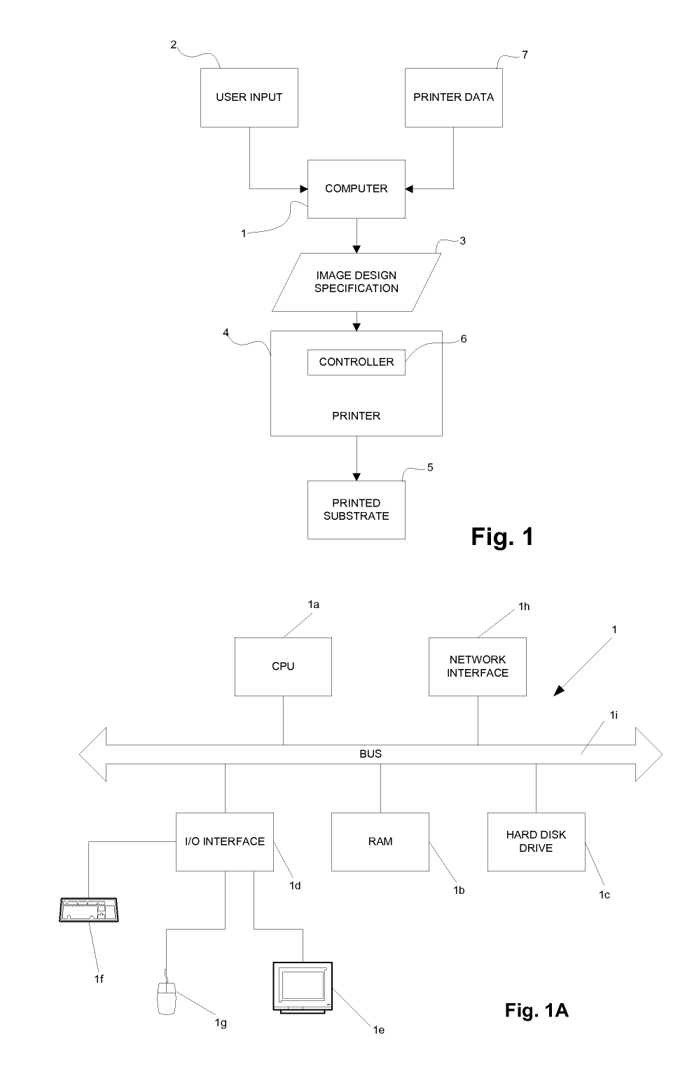

FIG. 1 is a schematic illustration of an arrangement suitable for carrying out the invention;

FIG. 1A is a schematic illustration of a computer of the arrangement of FIG. 1;

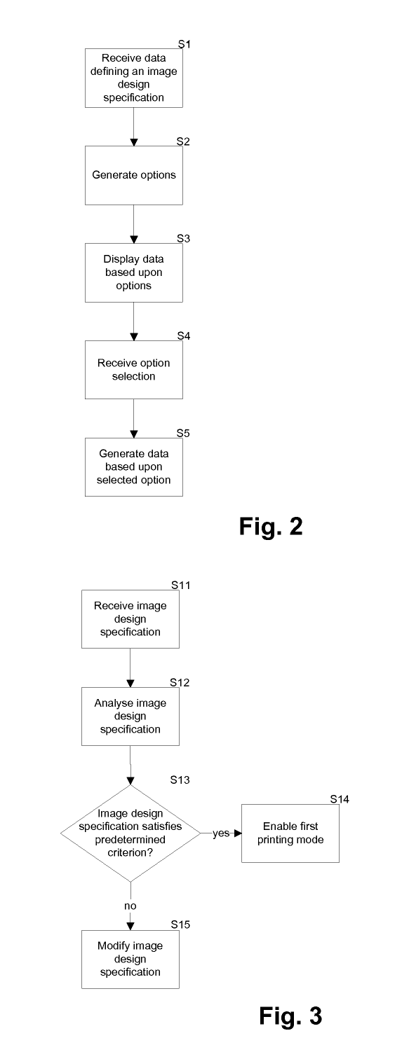

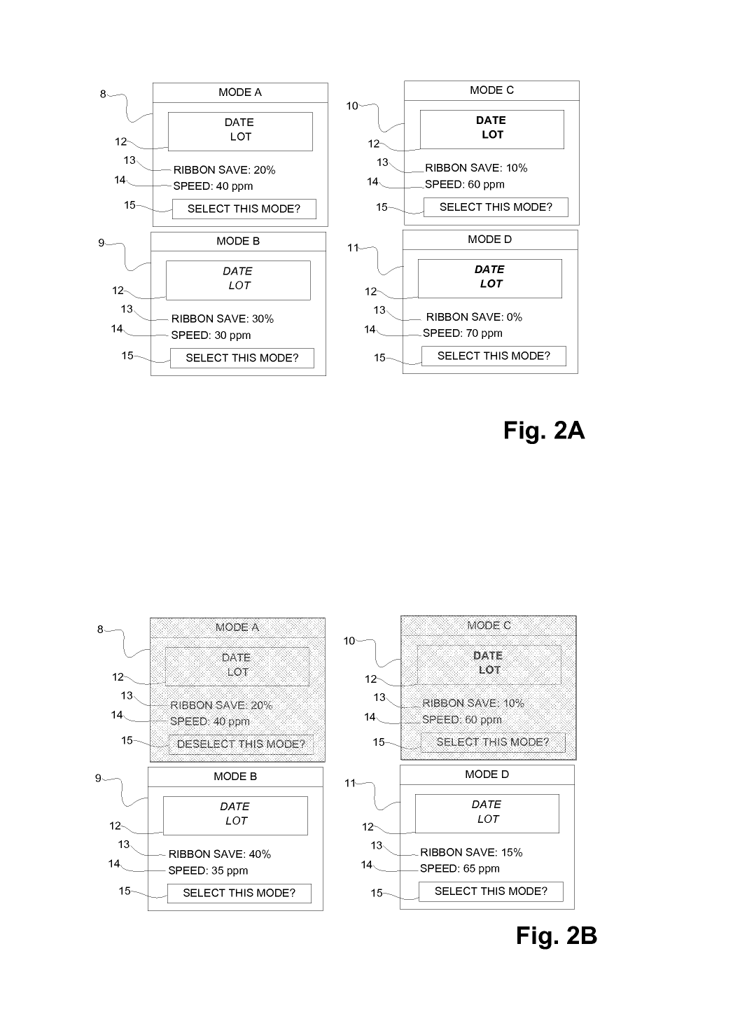

FIG. 2 is a flowchart showing processing carried out to generate an image for printing in accordance with an aspect of the invention;

FIG. 2A is a schematic illustration of a user interface suitable for use in the processing of FIG. 2;

FIG. 2B is a schematic illustration of the user interface of FIG. 2A, updated after a user input;

FIG. 3 is a flowchart showing processing carried out to analyse an image design specification;

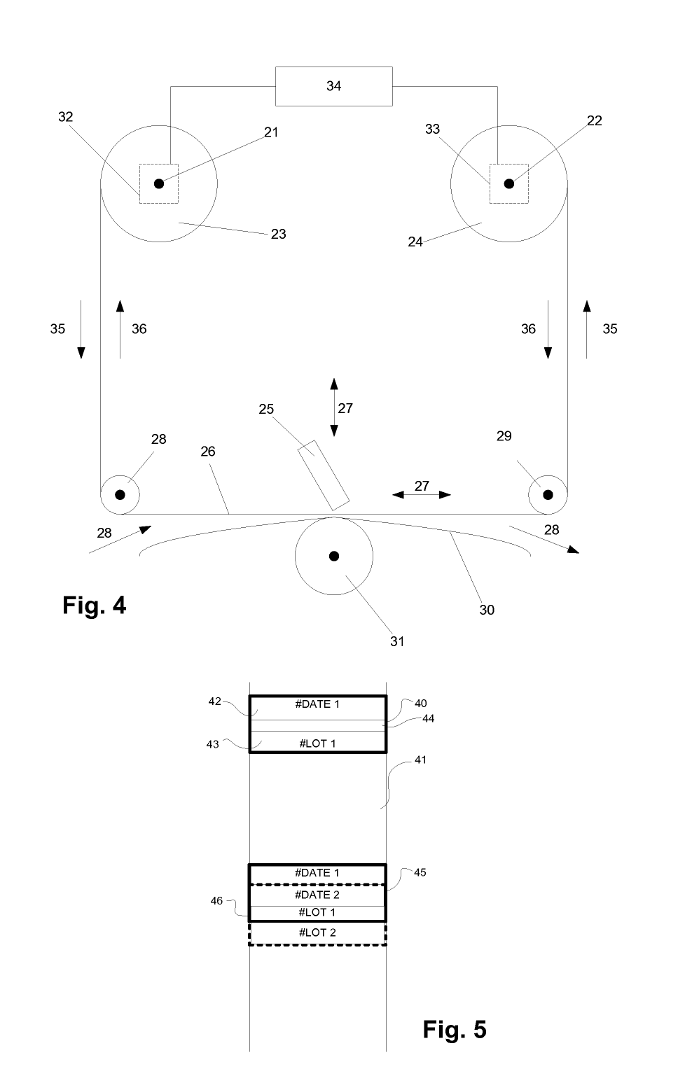

FIG. 4 is a schematic illustration of a user interface suitable for receiving user input data defining an image design specification;

FIG. 4 is a schematic illustration of a printer tape drive system suitable for printing image data generated according to the invention; and

FIG. 5 is a schematic illustration of use of a tape for printing.

Referring to FIG. 1, a computer 1 is arranged to receive user input 2 for generation of an image design specification 3. The image design specification 3 typically takes the form of a design template for a printer 4 to print information on a substrate to generate a printed substrate 5 in accordance with the image design specification 3. The image design specification may take any convenient form and may, for example, be a generic file format that can be read by a plurality of different printers.

For example, the image design specification 3 may specify a plurality of data fields associated with information to be included in a printed image and may additionally specify locations and fonts for the information. The data fields may be associated with information such as a use by date to be printed onto packaging of a plurality of consumer products. The information may be added by a controller 6, which is typically embedded within the printer 4, that generates image data for the printer at the time of printing based upon further information such as the date of printing and product details that may not be available at the time of generation of the image design specification 3. In this way, the image design specification 3 provides a layout for printing an image including information without requiring the information to be available at the time of the generation of the image design specification 3. It will of course be appreciated that the image design specification may be created using software running on the printer and the processing described below may be carried out by software running on the printer. That is, the computer 1 may form part of the printer 4.

The computer 1 is further arranged to receive printer data 7 that may be used in the generation of the image design specification 3. The printer data 7 may include data such as a rate at which the printer is able to print onto substrates, a print region size such as a number of pixels that can be printed onto each substrate, a substrate speed, a print head movement speed, a time to heat individual print head elements and a length of portion of substrate between prints in which no information is printed, as well as other data relating to the printer such as widths of ribbon that can be used by the printer that will be known to the skilled person. The rate at which the printer is able to print onto substrates may take any convenient form. For example, the rate may take the form of a number of meters of substrate that can be printed in a time period such as a minute.

The printer data 7 may additionally include print options available to the printer. For example, the printer may have a plurality of print modes that allow the printer to be operated in a manner that provides advantageous printer operation, for example a reduction in the usage of ink relative to a standard print mode or an increase in the possible print rate, but such modes typically have an associated effect on the printed image, for example a reduction in printed image resolution.

FIG. 1A shows the computer 1 in further detail. It can be seen that the computer comprises a CPU 1a which is configured to read and execute instructions stored in a volatile memory 1b which takes the form of a random access memory. The volatile memory 1b stores instructions for execution by the CPU 1a and data used by those instructions. For example, in use, data such as user input 2 and printer data 7 may be stored in volatile memory 1b.

The computer 1 further comprises non-volatile storage in the form of a hard disc drive 1c. Data such as user input 2 and printer data 7 may be stored on hard disc drive 1c. The computer 1 further comprises an I/O interface 1d to which are connected peripheral devices used in connection with the computer 1. More particularly, a display 1e is configured so as to display output from the computer 1 such as output generated during the processing to generate the image design specification 3, as described below. Input devices are also connected to the I/O interface 1d. Such input devices may include a keyboard if and a mouse 1g which allow user interaction with the computer 1. It will be appreciated that the computer may have other input interfaces, for example a touch screen.

A network interface 1h allows the computer 1 to be connected to an appropriate communications network so as to receive and transmit data from and to other computers and/or the printer 4. For example, the image design specification 3 may be transmitted to the printer 4 for processing by the controller 6 using a communications network. Alternatively the computer 1 may have interfaces suitable for receiving and communicating with removable devices such as a USB port for receiving a USB data storage device and the image design specification 3 may be transmitted to the printer 4 using such a USB data storage device. The CPU 1a, volatile memory 1b, hard disc drive 1c, I/O interface 1d, and network interface 1h, are connected together by a bus 1i.

Referring to FIG. 2, processing carried out by computer 1 to generate data associated with printing an image is shown. At step S1 data defining an image design specification is received. The data defining the image design specification may be received for example by receiving user input specifying a template for printing images to generate the image design specification. For example a user interface may be provided to the user that allows the user to specify image components and layout of those components within printed regions of the substrate. Alternatively the data defining the image design specification may be provided as input as an image design specification for processing to modify the input image design specification.

At step S2 a plurality of options for printing an image based upon the image design specification are generated. The plurality of options for printing may, for example, be received as printer data 7 or may be generated by the computer, for example using a lookup of printer options for the printer 4 that is to be used to print the image. The plurality of print options generally take the form of print modes available to the printer as described with reference to FIG. 1.

At step S3 data is displayed to a user based upon the plurality of options received at step S2. The data displayed to the user indicates information associated with printing an image based upon the image design specification for each of the plurality of options and may take various forms. For example, the data displayed to the user may include a number of images that can be printed based upon the image design specification in a given time period, for example a number of images per minute defining a number of bags per minute. In particular, the substrate typically takes the form of a continuous sheet of pre-printed substrate, the substrate being pre-printed with artwork associated with a plurality of packages. After the substrate has been printed the substrate is cut to form the plurality of packages. For example, the substrate may be pre-printed with a plurality of bags, which are typically identical, and after additional information has been printed on a portion corresponding to each of the bags the substrate is cut to form a plurality of bags including individual data. The number of images that can be printed based upon the image design specification may therefore provide an indication of a maximum number of individual packages, which may for example be bags that can be printed in the time period.

The data displayed to the user may additionally or alternatively include an indication of ink usage for each of the plurality of options. The ink usage may be displayed for example as an absolute ink usage or as ink usage relative to other ones of the options. The ink usage may take any convenient form, for example an indication of ink ribbon usage for a predetermined number of images. Additionally or alternatively the data displayed to the user may include an image indicating the effect upon images printed based upon the image design specification using each of the plurality of options.

At step S4 a selection of one of the options is received from the user and at step S5 data associated with printing an image based upon the selected option is generated. For example, the generated data may be data that causes a printer to print images based upon the image design specification using the selected option. Such an indication may take any convenient form and may for example be an indication provided to a user to use the selected option, may take the form of data included in the image design specification that can cause the printer to use the selected option for printing as a default, or may be provided to the printer directly in any suitable manner.

Alternatively, in some embodiments it may be possible to combine options. Where options may be combined, selection of one of the options received at step S4 may cause the computer to display updated data based upon remaining options. The updated data may indicate similar information to the user as displayed at step S3, but updated to take into account the selection received at step S4. For example, options that are no longer available may be removed or displayed in a way that indicates that the option is no longer available. The displayed data may additionally or alternatively be updated to indicate information associated with the combination of remaining options with the option selected at step S4. For example, where the data displayed to the user includes an image indicating the effect upon images printed based upon the image design specification using each of the plurality of options, the image may be updated to show the effect upon images printed based upon the image design specification using the combination of the option selected at step S4 and each of the plurality of remaining options.

As indicated above, a printer to be used to print images based upon an image design specification may have a plurality of print modes that allow the printer to be operated in a manner that provides advantageous printer operation, for example a reduction in the usage of ink relative to a standard print mode or an increase in the possible print rate, but that typically has an associated effect on the printed image, for example a reduction in printed image resolution. Examples of such print modes are described in

International Patent Publication Numbers WO2006/013348, WO2002/070267 and WO2002/022371, which are incorporated herein by reference. For example, WO2002/022371 describes with reference to FIGS. 13 to 16 and 22 an interleaved printing mode. Displaying data to a user based upon the plurality of available options provides information to the user that assists in the selection of one of the plurality of options and can provide improvements, for example in speed and ink usage, with associated effects on printed image quality that have been assessed and deemed acceptable.

An example user interface suitable for displaying data to a user at step S2 of FIG. 2 is illustrated in FIGS. 2A and 2B. User interface areas 8, 9, 10, 11 are each associated with a respective mode. Each user interface area 8, 9, 10, 11 displays data associated with the respective mode. For example, shown in FIG. 2A each interface area includes a display area 12 that displays a representation of an image that would be printed based upon the currently processed image design specification using the respective mode, an indication 13 of a ribbon saving using the respective mode and an indication of a speed using the respective mode, for example a number of prints per minute such as a number of bags printed per minute. It will of course be appreciated that other information may be displayed.

Each interface area further includes a button 15 that allows the respective mode to be selected by a user. FIG. 2B illustrates an updated user interface after user selection of mode A. As described above, in some embodiments some of the modes may be combined and such possible combination can be highlighted to a user. For example in FIG. 2B modes B and D may be combined with the selected mode A and mode C is greyed to indicate that mode C cannot be combined with selected mode A. Additionally, button 15 of selected mode A is changed to show that mode 1 is selected and provides an option to a user to deselect the selected mode. Information displayed in available modes B and D is additionally updated to show the effect of combination of the currently selected mode with the further selected mode.

Referring now to FIG. 3, processing for modifying an image design specification to optimise a printing process is shown. At step S11 data defining the image design specification is received. As indicated above, the image design specification specifies a layout for printing an image including information that may not be available when the image design specification is created and that can be added in before printing.

At step S12 the image design specification is processed to determine whether the image design specification satisfies a predetermined criterion. The predetermined criterion may be based upon printer data associated with the printer with which images are to be printed using the image design specification and may therefore allow the image design specification to be assessed against known properties of the printer such as properties associated with a printing mode associated with the printer, and allows modifications to be made to the image design specification that provide improved printing, for example by allowing use of a printing mode associated with the printer. For example, as described in further detail below, the image design specification may be modified to allow a printing mode that provides improved printing speed and/or improved ink usage.

If it is determined at step S12 that the image design specification satisfies the predetermined criterion, at step S14 a printing mode associated with the predetermined criterion is enabled. Otherwise at step S15 the image design specification is modified such that the predetermined criterion is satisfied.

It will be appreciated that the modification may be automatically effected, or alternatively a user may be provided with an option to allow modification of the image design specification in the event that the predetermined criterion is not satisfied before any modification is made. For example, in some embodiments the image design specification may be processed to determine whether a plurality of predetermined criteria are satisfied, each of the plurality of predetermined criteria being associated with a respective printing mode, and the user may be provided with an indication of printing modes with which the image design specification can be used, and/or modifications that can be made to the image design specification to allow use of each of the printing modes.

In order to illustrate the methods described above with reference to FIGS. 2 and 3, the invention will now be described with reference to a specific type of printer, a thermal transfer printer, and associated printing modes, however it will be appreciated that the invention can be used in the generation of image design specifications for printing images using any suitable printer.

Referring to FIG. 4, part of a thermal transfer printer is schematically illustrated. First and second shafts 21, 22 support a supply spool 23 and a take-up spool 24 respectively. The supply spool 23 is initially wound with a roll of unused tape, and the take-up spool 24 initially does not carry any tape. As tape is used, used portions of the tape are transported from the supply spool 23 to the take-up spool 24. A displaceable printhead 25 is provided, displaceable relative to tape 26 in at least a first direction indicated by arrow 27. Tape 26 extends from the supply spool 23 around rollers 28, 29 to the take-up spool 24. The path followed by the tape 26 between the rollers 28 and 29 passes in front of the printhead 25. A substrate 30 upon which print is to be deposited is brought into contact with the tape 26 between rollers 28 and 29, the tape 26 being interposed between the printhead 25 and the substrate 30. The substrate 30 may be brought into contact with the tape 26 against a platen roller 31.

The supply shaft 21 is driven by a supply motor 32 and the take-up shaft 22 may be driven by a take-up motor 33. The supply and take-up motors 32, 33 are illustrated in dashed outline, indicating that they are positioned behind the supply and take-up spools 23, 24. It will however be appreciated that in alternative embodiments of the invention, the spools are not directly driven by the motors. Instead the motor shafts may be operably connected to the respective spools by a belt drive or other similar drive mechanism.

A controller 34 controls the operation of motors 32, 33 as described in greater detail below. The supply and take-up motors 32, 33 may be capable of driving the tape 26 in both directions. Tape movement may be defined as being in the print direction if the tape is moving from the supply spool 23 to the take-up spool 24, as indicated by arrows 35. When tape is moving from the take-up spool 24 to the supply spool 23, the tape may be considered to be moving in the tape reverse direction, as indicated by arrows 36.

When the printer is operating in continuous mode the printhead 25 will be moved into contact with the tape 26 when the tape 26 is moving in the print direction 35. Ink is transferred from the tape 26 to the substrate 30 by the action of the printhead 25. Tape movement may be reversed such that unused portions of the tape 26 are positioned adjacent to the printhead 25 before a subsequent printing operation is commenced.

Alternatively the printer may operate in intermittent mode. When the printer operates in intermittent mode the roller platen 31 is replaced by a flat platen and the substrate 30 is not moved such that the print head 25 is moved relative to the tape and substrate and into contact with the tape 26 when the tape 26 and substrate 30 is stationary.

In the configuration illustrated in FIG. 4 the spools 23, 24 are wound in the same sense as one another and thus rotate in the same rotational direction to transport the tape. Alternatively, the spools 23, 24 may be wound in the opposite sense to one another, and thus must rotate in opposite directions to transport the tape.

Each area of the tape 26 can be used a single time to print an image region on the substrate 30. It will be appreciated that printing an image will typically use only parts of a contiguous region of tape 26 corresponding to the area of the image that is printed and various modes have been developed to allow reuse of areas of a contiguous region of tape. Examples of such modes are described in International Patent Publication Numbers WO2006/013348, WO2002/070267 and WO2002/022371.

As described above, the modes typically have an effect on the image. For example, a mode for a thermal transfer printer described in WO2002/022371 prints each image using only some of the pixels of the image data. By selecting different subsets of image pixels and corresponding tape areas for printing successive images, the same, or at least an overlapping, contiguous region of tape can be used to print the successive images. Such a mode can provide reduced tape usage and an increase in print speed but with a corresponding reduction in print resolution due to the printing of only some of the pixels of the image data.

The method described with reference to FIG. 2 provides a way in which such information can be used, for example at the time of creation of the image design specification, to improve the selection of print options. As the information can be made available at the time of creation of the image design specification, the selection of modes can be made by a skilled operator such as the image design specification creator, and additionally can be used to interactively improve the creation of image design specification. Providing information at the time of creation of the image design specification in this way allows decisions to be made by the most appropriate individual and can avoid such decisions being made by operators of the print process who are typically less able or willing to make such decisions.

Use of a mode such as that described in WO2002/022371 may depend on the image design specification, or images that may be generated based upon the image design specification, having particular properties. For example, in order to use the mode described in WO2002/022371 it may for example be necessary that images generated based upon the image design specification have a minimum pixel density. The method described with reference to FIG. 3 determines whether a criterion such as a minimum pixel density is satisfied and if the criterion is satisfied can automatically select the associated printing mode. However if the criterion is not satisfied, it may be possible to modify the image design specification to allow use of the desired printing mode without adversely affecting the images that are printed based upon the image design specification. For example, it may be possible to increase a font size specified in the image design specification and such an increase in font size may result in the necessary pixel density without affecting other operational parameters. Such an increase in font size may therefore counter intuitively provide a reduction in tape usage due to the increase in font size allowing a print mode to be used that saves more tape than the corresponding increase in tape use caused by the increased font size.

By way of further example, typically thermal transfer printers have a small number of predetermined tape sizes that may be used for printing. Analysis of the image design specification can automatically provide image design specification modifications that allow use of a different tape size that results in a reduction in cost. For example, the image design specification may be analysed to determine whether selection of a different font (for example a different typeface or a different font size) could allow for use of a smaller tape size that has a lower cost by determining whether the maximum possible image size, determined based upon information that may be combined with the image design specification by the printer provide the image data to be printed, can be reduced.

By way of further example, the image design specification typically specifies spacing in which no image data is provided between image elements. The image design specification may be processed to determine whether the spacing specified in the image design specification allows use of available print modes. For example, as illustrated in FIG. 5, an image design specification may specify that a portion 40 of a tape 41 is used to print an image on a first substrate, with a date value, inserted by a printer, being printed using portion 42 of the tape and a lot number for the first substrate being printed using portion 43 and a space 44 between the date and lot number. The image design specification may be analyzed and it may be determined that a print mode of the printer allows the ribbon to be used to print an image on a second substrate using a portion of tape that overlaps with the portion 40 used to print the first substrate. The analysis may however determine that the space 44 is insufficient for the print mode to be used and therefore provide a modification to the user in which the space 44 is increased. The modification may therefore allow printing in which overlapping portions 45, 46 of tape 41 are used to print successive substrates and in which tape use is reduced.

It is described above that a bags printed per minute may be calculated. The calculation for the number of bags printed per minute depends upon a number of factors and will generally be different for different printers with which the invention may be used. However by way of example a calculation for a number of bags printed per minute will now be described for a thermal transfer printer operating in intermittent mode and operating in continuous mode.

Turning first to a thermal transfer printer operating in intermittent mode, as described above when the printer operates in intermittent mode the print head 25 is moved relative to the tape and substrate and into contact with the tape 26 when the tape 26 and substrate 30 is stationary.

The number of bags printed per minute, IntermittentThroughput, may be calculated for a thermal transfer printer operating in intermittent mode according to (1):

IntermittentThroughput=60*(1/CycleTime) (1)

where CycleTime is the time taken to complete a print cycle in which an image is printed on a bag and generally consists of the time taken to print an image together with overheads associated with the operation of printing the image.

In more detail, the value CycleTime may be calculated according to (2):

CycleTime=IntermittentPrintTime+CycleOverheadTime+RewindCycleTime (2)

where:
IntermittentPrintTime is the time taken to print an image;
CycleOverheadTime is an empirically determined value based upon the head out time, corresponding to the time taken for print head to platen pressure to become stable plus the turn time, corresponding to the minimum time period that the head must remain stationary when changing direction and additionally including a 5 millisecond dwell time, corresponding to a time that is enforced between prints during which the print head is not moving; and
RewindCycleTime is the larger of the ribbon return time, corresponding to the time taken to move the print head the length of the image to be printed plus 0.5 mm, and the head return time corresponding to the time required to return the print head to the necessary position for printing a subsequent image.

The value IntermittentPrintTime may be calculated based upon the time taken to accelerate the print head to the required print velocity and the distance that the print head is required to move, for example according to (3):

IntermittentPrintTime=(IntermittentAccelerationTime*2)+((HeadMovementDistance−(2*IntermittentAccelerationDistance))/PrintSpeed) (3)

where:
PrintSpeed is the desired velocity of the print head for printing the image;
IntermittentAccelerationTime is the time taken to accelerate the print head from a velocity of zero to the velocity PrintSpeed and correspondingly the time taken to decelerate the print head from the PrintSpeed to a velocity of zero;
HeadMovementDistance is the distance that the head moves during the print operation to print the image including the distance moved during which the head is accelerating from a velocity of zero to the velocity PrintSpeed, the distance moved during the printing of the image and the distance moved during which the head is decelerating from the velocity PrintSpeed to a velocity of zero;
IntermittentAccelerationDistance is the distance required to accelerate the print head to the print velocity and is determined using a lookup table based upon parameters of the printer.

The value ((HeadMovementDistance−(2*IntermittentAccelerationDistance))/PrintSpeed) therefore provides the time taken to print the image without taking into account the time taken during acceleration and deceleration, which is already accounted for in the value IntermittentPrintTime by the value IntermittentAccelerationTime*2.

Alternatively, where the value (HeadMovementDistance/2) is less than the value IntermittentAccelerationDistance indicating that insufficient distance is available for accelerating the print head to the desired velocity and for decelerating the print head from the desired velocity, the value IntermittentPrintTime may be calculated according to (4):

IntermittentPrintTime=IntermittentAccelerationTimeOverDistance*2 (4)

where the value IntermittentAccelerationTimeOverDistance provides a time taken for the acceleration of the print head over half of the required head movement distance for the print, corresponding to the sum of the distance for the start border plus the distance for the image plus an enforced 0.5 mm distance between images. In particular, where insufficient distance is available for accelerating the print head to the desired velocity and for decelerating the print head from the desired velocity the, print head accelerates for half of the total distance travelled and decelerates for half of the total distance travelled during the print operation and the time taken can therefore be calculated based upon the acceleration time and the deceleration time.

For a thermal transfer printer operating in continuous mode, as described above the printhead 25 will be moved into contact with the tape 26 when the tape 26 is moving in the print direction 35. The number of bags printed per minute, ContinuousThroughput, is calculated for a thermal transfer printer operating in continuous mode based upon a provided substrate speed, PrintSpeed, according to (5):

ContinuousThroughput=60*(1/(BagLength/PrintSpeed)) (5)

where BagLength is the length of a bag.

However it will be appreciated that for a given BagLength and image a printer will have a maximum substrate speed for which the printer will be capable of printing the image on each bag. As such, for any given image and BagLength it is possible to determine a maximum substrate speed, PrintSpeed, and corresponding number of bags printed per minute, ContinuousThroughput, at which the printer is able to print for example by iteratively processing values of PrintSpeed to determine whether the distance required to complete a print at the substrate speeds is less than the BagLength.

The distance required to complete a print at a substrate speed PrintSpeed for a printer operating in continuous mode, ContinuousRepeatDistance, may be determined according to (6):

ContinuousRepeatDistance=PrintSpeed*ContPrintFeedTime (6)

where ContPrintFeedTime is the total time taken for a print cycle including printing the image to be printed and preparing the printer for the next cycle.

The value ContPrintFeedTime may be determined according to (7):

ContPrintFeedTime=ContPrintTime+0.003+RewindTime (7)

where:
ContPrintTime is the time for printing the image;
RewindTime is the time required to rewind the tape after the image has been printed in order to reclaim tape that is not used during the printing of the image but which passes the print head during the cycle; and
the value 0.003 is an empirically determined value that provides 3ms for other factors such as turn time.

The value ContPrintTime may be determined according to (8):

ContPrintTime=Accel+Border+ImagePrint+HeadInReaction+Decel (8)

where:
Accel is the maximum time that may be required to accelerate the tape to the required speed to match the change in speed of the substrate between image prints, for example calculated based upon a known maximum variability of the tape speed;
Border is the time required to allow for a start border before printing the image and may additionally include an error margin;
ImagePrint is the time required to print the image;
HeadInReaction is the time required for the print head reaction time based upon a known parameter of the printer; and
Decel is the time required to decelerate the tape after the image has been printed.

The value RewindTime may be determined based upon a speed at which the tape can be rewound and the amount of tape that is required to be rewound. The amount of tape that is required to be rewound will vary based upon the speed of the substrate PrintSpeed. In particular, as the value PrintSpeed increases the amount of tape that is required to be rewound also increases, given that the tape speed required to match the PrintSpeed increases, the time to decelerate the tape increases given the greater tape speed and accordingly the tape moves a greater distance. It will be appreciated that the RewindTime therefore increases non-linearly as the substrate speed PrintSpeed increases.

Where empirically determined values are provided in the above calculations it will of course be appreciated that these values are exemplary only and other values may be used, for example by determining values for a particular printer empirically.

It will be appreciated that different modes will affect various parameters described above and accordingly will affect the number of bags per minute that can be printed. For example, where consecutive images are printed using overlapping regions of the tape the distance that the tape is required to be rewound will typically be affected and the time required for rewinding the tape will also therefore be affected. A change to the required rewind time will for example affect the maximum possible PrintSpeed in continuous mode and will therefore affect the bags per minute calculation. It will of course be appreciated that other factors than rewind time will typically vary between different print modes and the variation of the factors will combine to affect the bags per minute calculation set out above.

Although specific embodiments of the invention have been described above, it will be appreciated that various modifications can be made to the described embodiments without departing from the spirit and scope of the present invention. That is, the described embodiments are to be considered in all respects exemplary and non-limiting. In particular, where a particular form has been described for particular processing, it will be appreciated that such processing may be carried out in any suitable form arranged to provide suitable output data.

1. A method of generating data associated with printing an image, the method comprising:
receiving data defining an image design specification, wherein the image design specification specifies a plurality of data fields;
generating a plurality of options for printing an image based upon the image design specification;
displaying data based upon the plurality of options to a user;
receiving selection of one of the options from the user;
generating the data associated with printing an image based upon the selected option; and
printing an image based upon the generated data, wherein the printed image comprises information determined based upon the plurality of data fields specified in the image design specification, the image being printed using a printer selected from a continuous inkjet printer, a thermal transfer printer, and a drop-on-demand printer.

2. A method according to claim 1, wherein the image design specification further specifies relative positions of the plurality of data fields.

3. A method according to any preceding claim, wherein the options comprise options for controlling a printer to print an image based upon the image design specification.

4. A method according to any preceding claim, wherein the printing is to be performed by a transfer printer and the options comprise options affecting efficiency of tape usage and/or speed of printing.

5. A method according to any preceding claim, wherein one of the options comprises omitting printing parts of the image defined by the image design specification.

6. A method according to claim 5, wherein one of the options comprises:
printing a plurality of parts of the image defined by the image design specification;
omitting a plurality of parts of the image defined by the image design specification, the omitted parts being located intermediate printed parts of the image, so as to allow for interleaving of images on a transfer medium.

7. A method according to any preceding claim, further comprising:
determining a plurality of printer operational parameters;
wherein generating the plurality of options for printing an image is based upon the image design specification and the printer operational parameters.

8. A method according to claim 7, wherein the printer operational parameters are selected from the group consisting of:
print speed;
substrate speed;
a substrate distance between two consecutive prints; and
a dimension.

9. A method according to any preceding claim, wherein the data displayed based upon the plurality of options consist of, for each option, at least one of:
a speed of printing;
an efficiency of tape usage; and
a graphical representation of an image printed based upon the image design specification.

10. A method according to any preceding claim, wherein the generated data comprises data based upon a combination of the selected option and other ones of the plurality of options.

11. A method according to claim 10, further comprising displaying data based upon the combination of the selected option and other ones of the plurality of options.

12. A method according to claim 11, wherein the displayed data indicates which of the other ones of the plurality of options that are combinable with the selected option.

13. A method according to claim 11 or 12, wherein the displayed data indicates an effect of combining other ones of the plurality of options with the selected option.

14. A method according to any preceding claim, wherein the generated data associated with printing an image based upon the selected option comprises data arranged to cause a printer to print images based upon the image design specification using the selected option.

15. A computer program comprising computer readable instructions configured to cause a computer to carry out a method according to any one of claims 1 to 14.

16. A method for modifying an image design specification to optimise a printing process, the method comprising:
analysing the image design specification to determine whether the image design specification satisfies a predetermined criterion;
if the analysis determines that the image design specification satisfies the predetermined criterion, generating output associated with a first printing mode associated with the predetermined criterion, wherein the first printing mode is a mode for controlling a printer to print an image based upon the image design specification;
if the analysis determines that the image design specification does not satisfy a predetermined criterion, providing a modification of the image design specification based upon the first printing mode; and
printing an image based upon the output, the image being printed using a printer selected from a continuous inkjet printer, a thermal transfer printer, and a drop-on-demand printer.

17. A method according to claim 16, wherein the printing is to be performed by a transfer printer and the printing modes affect efficiency of tape usage and/or speed of printing.

18. A method according to any one of claims 16 to 17, wherein analysing the image design specification comprises analysing unprinted regions indicated by the image design specification.

19. A method according to any one of claims 16 to 18, wherein providing a modification of the image design specification comprises modifying the image design specification such that the image design specification satisfies the predetermined criterion.

20. A method according to any one of claims 16 to 19, wherein providing a modification of the image design specification comprises modifying unprinted regions indicated by the image design specification

21. A method according to any one of claims 16 to 20, wherein analysing the image design specification comprises determining a pixel density associated with the image design specification.

22. A method according to any one of claims 16 to 21, wherein providing a modification of the image design specification comprises modifying a font associated with the image design specification.

23. A method according to any one of claims 16 to 22, wherein providing a modification of the image design specification comprises modifying a size of an image region associated with the image design specification.

24. A method according to any one of claims 16 to 23, wherein providing a modification of the image design specification comprises displaying an effect of a suggested modification of the image design specification.

25. A method according to claim 24, further comprising receiving user input based upon the suggested modification and modifying the image design specification based upon the user input.

26. A method according to any one of claims 16 to 25, further comprising:
analysing the image design specification to determine whether the image design specification satisfies a further predetermined criterion;
generating respective output associated with a printing mode associated with each predetermined criterion satisfied by the image design specification; and
providing a respective modification of the image design specification for each predetermined criterion not satisfied by the image design specification.
